(19) United States
(12) Patent Application Publication
(10) Pub. No.: US 2026/0312248 A1
(43) Pub. Date: Oct. 8, 2026

(54) ELECTRODE, SECONDARY BATTERY, AND ELECTRODE MANUFACTURING APPARATUS

(71) Applicant: Samsung SDI Co., Ltd., Yongin-si (KR)

(72) Inventors: Eun Hyeok Shin, Suwon-si (KR); Jung Ah Yoon, Suwon-si (KR); Tae Su Jeong, Suwon-si (KR)

(73) Assignee: Samsung SDI Co., Ltd., Yongin-si (KR)

(21) Appl. No.: 19/635,953

(22) Filed: Apr. 1, 2026

(30) Foreign Application Priority Data
Apr. 2, 2025 (KR) 10-2025-0042854

(51) Int. Cl. H01M 50/534; H01M 4/04; H01M 4/134; H01M 4/1395; H01M 10/052; H01M 10/0587; H01M 50/105; H01M 50/178; H01M 50/533; H01M 50/536; H01M 50/538

(52) U.S. Cl. CPC H01M 50/534; H01M 4/0435; H01M 4/134; H01M 4/1395; H01M 10/052; H01M 10/0587; H01M 50/105; H01M 50/178; H01M 50/533; H01M 50/536; H01M 50/538

(57) ABSTRACT

The present disclosure relates to an electrode including a composite substrate, and a technical problem to be solved is to provide an electrode including a composite substrate that is easily bonded to a substrate tab. To this end, the present disclosure provides an electrode that includes a composite substrate including a metal layer comprising a first metal layer and a second metal layer and an insulating layer located between the first metal layer and the second metal layer, and a substrate tab including a first metal and bonded to one side of at least one surface of the composite substrate, wherein the substrate tab includes a second metal different from the first metal on a surface of the substrate tab.

### CROSS-REFERENCE TO RELATED APPLICATION

This present application claims priority to and the benefit under 35 U.S.C. § 119(a)-(d) of Korean Patent Application No. 10-2025-0042854, filed on Apr. 2, 2025, in the Korean Intellectual Property Office, the entire disclosure of which is incorporated herein by reference.

### BACKGROUND

### Field

The present disclosure relates to an electrode, a secondary battery, and an electrode manufacturing apparatus.

### Description of the Related Art

Generally, with the rapid spread of electronic devices using batteries in recent years, such as mobile phones, notebook computers, and electric vehicles, demand for secondary batteries having high energy density and high capacity has been rapidly increasing. Accordingly, research and development for improving the performance of lithium secondary batteries are being actively conducted.

A lithium secondary battery is a battery including a positive electrode and a negative electrode each including an active material capable of intercalating and deintercalating lithium ions, and an electrolyte, and generating electrical energy by oxidation and reduction reactions when lithium ions are intercalated into and deintercalated from the positive electrode and the negative electrode.

The herein-described information disclosed in the background technology of this disclosure is only intended to improve understanding of the background of the present disclosure and therefore may include information that does not constitute related art.

### SUMMARY

The present disclosure is directed to providing an electrode having improved bonding strength between a composite substrate and a substrate tab and/or a secondary battery including such an electrode.

The present disclosure is also directed to providing an electrode manufacturing apparatus for manufacturing an electrode having improved bonding strength between a composite substrate and a substrate tab.

The present disclosure is also directed to minimizing a degree to which pinholes are generated in a joint portion between a composite substrate and a substrate tab.

However, technical problems to be solved by the present disclosure are not limited to the problems described herein, and other problems that have not been described may be clearly understood by those skilled in the art from the description of the disclosure described herein.

According to one embodiment of the present disclosure, there is provided an electrode including: a composite substrate including a metal layer comprising a first metal layer and a second metal layer and an insulating layer located between the first metal layer and the second metal layer; and a substrate tab including a first metal and bonded to one side of at least one surface of the composite substrate, wherein the substrate tab includes a second metal different from the first metal on a surface of the substrate tab.

For example, a melting point of the second metal may be higher than a melting point of the first metal.

For example, a melting point of the second metal may be at least 350 °C higher than a melting point of the first metal.

For example, the substrate tab may be welded to the metal layer through a joint portion, and the joint portion may have a volume fraction of pinholes of less than 5%.

For example, the joint portion may be formed by ultrasonic welding.

For example, the electrode may further include a mixture layer provided on an other side of the composite substrate opposite the at least one surface of the composite substrate.

According to another embodiment of the present disclosure, there is provided a secondary battery that includes: an electrode assembly including a first electrode, a second electrode, and a separator located between the first electrode and the second electrode; a case accommodating the electrode assembly; and a lead tab that is electrically connected to the electrode assembly and exposed outside the case, wherein at least one of the first electrode or the second electrode includes: a composite substrate including a metal layer comprising a first metal layer and a second metal layer and an insulating layer located between the first metal layer and the second metal layer; and a substrate tab including a first metal and having one side bonded to one side of at least one surface of the composite substrate and an other side bonded to the lead tab, and the substrate tab includes a second metal different from the first metal on a surface of the substrate tab.

For example, a melting point of the second metal may be higher than a melting point of the first metal.

For example, a melting point of the second metal may be at least 350 °C higher than a melting point of the first metal.

For example, the substrate tab may be welded to the metal layer through a joint portion, and the joint portion may have a volume fraction of pinholes of less than 5%.

For example, the joint portion may be formed by ultrasonic welding.

For example, the first electrode and/or the second electrode including the composite substrate may further include a mixture layer provided on the other side of the at least one surface of the composite substrate.

According to still another embodiment of the present disclosure, there is provided an electrode manufacturing apparatus including: a first transfer unit configured to transfer a composite substrate sheet, the composite substrate sheet comprising a first metal layer and a second metal layer, and an insulating layer located between the first metal layer and the second metal layer; a second transfer unit configured to transfer a substrate tab sheet including a first metal to at least one surface of the composite substrate; a third transfer unit configured to transfer a buffer sheet including a second metal onto the substrate tab sheet; and a pressing unit configured to press a stacked structure in which the composite substrate sheet, the substrate tab sheet, and the buffer sheet are stacked.

For example, the pressing unit may press the stacked structure to ultrasonically weld the composite substrate sheet and the substrate tab sheet.

For example, the substrate tab sheet may have a volume fraction of pinholes of less than 5% in a portion of the substrate tab sheet that is ultrasonic-welded to the composite substrate sheet.

For example, the electrode manufacturing apparatus may further include a separation roller configured to separate the buffer sheet from the pressed stacked structure.

For example, in the stacked structure from which the buffer sheet is separated, the substrate tab sheet may include the second metal on at least a portion of a surface of the substrate tab sheet.

For example, a melting point of the second metal may be higher than a melting point of the first metal.

For example, a melting point of the second metal may be at least 350 °C higher than a melting point of the first metal.

For example, a thickness of the buffer sheet may be formed to be 1.0 to 1.5 times a thickness of the substrate tab sheet.

### BRIEF DESCRIPTION OF THE DRAWINGS

The following drawings attached to the present specification illustrate exemplary embodiments of the present disclosure and further describe aspects and features of the present disclosure together with the detailed description of the present disclosure. Thus, the present disclosure should not be construed as being limited to the drawings, in which:

FIG. 1 is a perspective view schematically showing a secondary battery according to one embodiment of the present disclosure;

FIG. 2 is a perspective view schematically showing the secondary battery according to one embodiment of the present disclosure;

FIG. 3 is a schematic view showing a composite substrate according to one embodiment of the present disclosure;

FIG. 4 is a schematic view showing an electrode according to one embodiment of the present disclosure;

FIG. 5 is a schematic view showing an electrode according to one embodiment of the present disclosure;

FIG. 6 is a schematic view showing an electrode according to one embodiment of the present disclosure;

FIG. 7 is a schematic view showing an electrode manufacturing apparatus according to one embodiment of the present disclosure;

FIG. 8 is a view describing a method of manufacturing an electrode according to one embodiment of the present disclosure;

FIG. 9 is a view describing the method of manufacturing an electrode according to one embodiment of the present disclosure;

FIG. 10 is a view describing the method of manufacturing an electrode according to one embodiment of the present disclosure; and

FIG. 11 is a view describing a method of manufacturing an electrode according to one embodiment of the present disclosure.

### DETAILED DESCRIPTION

Hereinafter, exemplary embodiments of the present disclosure will be described in detail with reference to the attached drawings. Prior to this, terms or words used in this specification and claims should not be interpreted as being limited to ordinary or dictionary meanings and should be interpreted with meanings and concepts consistent with the technical idea of this disclosure based on the principle that the inventor can properly define the concept of a term in order to describe his or her disclosure in the best way. Accordingly, it is to be understood that the embodiments described herein and the configurations illustrated in the drawings are only some of the most exemplary embodiments of the disclosure and do not represent all of the technical ideas of the disclosure, and that there may be various equivalents and modifications that may replace them at the time of filing.

Furthermore, when used herein, the terms “comprise,” “include,” “comprising,” and/or “including” specify the presence of the mentioned shapes, numbers, steps, operations, members, elements, and/or groups thereof and are not intended to exclude the presence or addition of one or more other shapes, numbers, operations, members, elements, and/or groups thereof.

In addition, in order to help understand the disclosure, the attached drawings may not be drawn to actual scale, and the dimensions of some components may be exaggerated. In addition, the same reference numbers may be assigned to the same components in different embodiments.

The statement that two objects for comparison are “equal” means “substantially the same.” Therefore, substantially the same may include deviations that are considered low in the art, for example, deviations of less than 5%. Additionally, uniformity of a parameter over a given region may imply uniformity from an average perspective.

Although “first,” “second,” and the like are used to describe various components, the components are not limited by these terms. These terms are used only to distinguish one component from another, and unless otherwise specifically stated, it is to be understood that a first component may also be a second component.

Throughout the specification, unless otherwise specifically stated, each element may be singular or plural.

When an arbitrary configuration is placed “on (or under)” a component or “above (or below)” a component, it can mean not only that the arbitrary configuration is placed in contact with the top (or bottom) of the component, but also that other configurations can be interposed between the component and the arbitrary configuration placed on (or under) the component.

In addition, when a component is described as being “on,” “connected to,” or “coupled to” another component, the above components may be directly connected or coupled to each other, but it should be understood that another component may be “disposed” between the components, or the components may be “connected,” “coupled,” or “linked” through another component.

As used herein, the term “and/or” includes any and all combinations of one or more of the associated listed items. Furthermore, the use of “may” when describing embodiments of the present disclosure relates to “one or more embodiments of the present disclosure.” Phrases such as “at least one” and “one or more” before a list of elements modify the entire list of elements and do not modify individual elements in the list.

Throughout the specification, “A and/or B” means A, B, or A and B unless otherwise stated to the contrary. When “C to D” is stated, it means greater than or equal to C and less than or equal to D unless otherwise specifically stated.

When phrases such as “at least one of A, B, and C,” “at least one of A, B, or C,” “at least one selected from group of A, B, and C,” or “at least one selected from A, B, and C” are used to specify a list of elements A, B, and C, the phrases may refer to any and all suitable combinations.

The term “use” may be considered synonymous with the term “utilize.” As used in the present specification, the terms “substantially,” “about,” and other similar terms are used as terms of approximation rather than terms of degree, and are intended to consider an inherent variation in measured or calculated values recognized by those skilled in the art.

Although the terms “first,” “second,” “third,” and the like may be used in the present specification to describe various elements, components, regions, layers and/or sections, these elements, components, regions, layers and/or sections should not be limited by these terms. These terms are used to distinguish one element, component, region, layer, or section from another element, component, region, layer, or section. Thus, a first element, component, region, layer, or section discussed herein could be named a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, when the elements or features in the drawings are inverted, an element described as “lower” or “below” becomes “upper” or “above.” Thus, the term “below” may encompass an orientation of both above and below.

The terms used in the present specification are intended to describe the embodiments of the present disclosure and are not intended to limit the present disclosure.

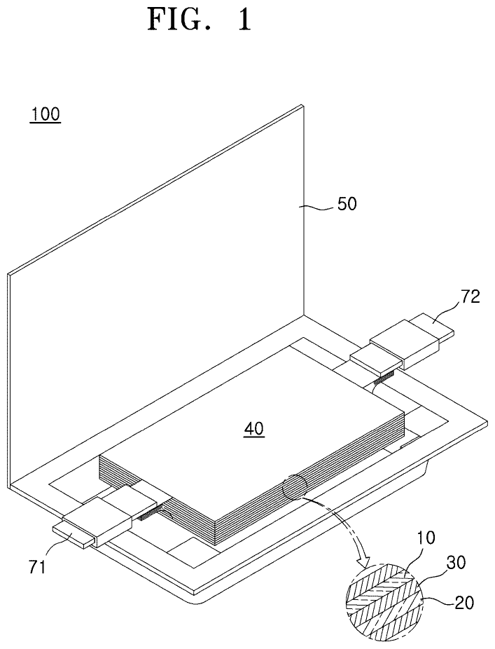

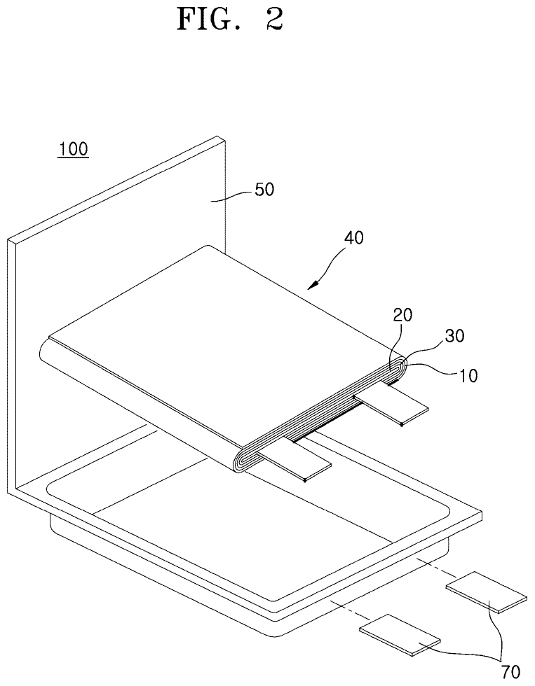

FIG. 1 is a perspective view schematically showing a secondary battery according to one embodiment of the present disclosure. FIG. 2 is a perspective view schematically showing the secondary battery according to one embodiment of the present disclosure.

A secondary battery 100 according to one embodiment of the present disclosure may include an electrode assembly 40 and a case 50.

The case 50 roughly forms an exterior of the secondary battery 100 and may accommodate the electrode assembly 40.

The electrode assembly 40 may function as a unit structure that performs charging and discharging operations of power in the secondary battery 100. The electrode assembly 40 may be accommodated inside the case 50.

The electrode assembly 40 may include a first electrode 10 and a second electrode 20. The first electrode 10 may be a positive electrode or a negative electrode. The second electrode 20 may be a negative electrode or a positive electrode and have a polarity different from that of the first electrode 10. Hereinafter, an example in which the first electrode 10 is a positive electrode and the second electrode 20 is a negative electrode will be described.

The electrode assembly 40 may further include a separator 30 located between the first electrode 10 and the second electrode 20. The separator 30 may prevent the first electrode 10 and the second electrode 20 from coming into contact with each other and prevent a short circuit from occurring between the first electrode 10 and the second electrode 20. The electrode assembly 40 may be formed by stacking the first electrode 10, the second electrode 20, and the separator 30 provided between the first electrode 10 and the second electrode 20.

A detailed description of each component of the electrode assembly 40 is as follows.

### Positive Electrode Active Material

As the positive electrode active material, a compound capable of reversible intercalation and deintercalation of lithium (a lithiated intercalation compound) may be used. Specifically, one or more composite oxides of lithium and a metal selected from cobalt, manganese, nickel, and a combination thereof may be used.

The composite oxide may be a lithium transition metal composite oxide, and specific examples thereof may include a lithium nickel-based oxide, a lithium cobalt-based oxide, a lithium manganese-based oxide, a lithium iron phosphate-based compound, a cobalt-free nickel-manganese-based oxide, or combinations thereof.

For example, a compound represented by any one of the following chemical expressions may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D₆₀ (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the chemical expression, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

For example, the positive electrode active material may be a high-nickel-based positive electrode active material in which a content of nickel, based on 100 mol % of metals excluding lithium in a lithium transition metal composite oxide, is 80 mol % or more, 85 mol % or more, 90 mol % or more, 91 mol % or more, or 94 mol % or more and 99 mol % or less. The high nickel-based positive electrode active material may realize high capacity and thus may be applied to high capacity, high density lithium batteries.

### Positive Electrode

The positive electrode for the secondary battery 100 may include a positive electrode substrate and a positive electrode mixture layer formed on the positive electrode substrate. The positive electrode mixture layer may include a positive electrode active material and may further include a binder and/or a conductive material.

For example, the positive electrode may further include an additive that can act as a sacrificial positive electrode.

The content of the positive electrode active material may be 90 wt % to 99.5 wt % with respect to 100 wt % of the positive electrode mixture layer, and the contents of the binder and the conductive material may be 0.5 wt % to 5 wt %, respectively, with respect to 100 wt % of the positive electrode mixture layer.

The binder serves to securely adhere positive electrode active material particles to each other and also to securely adhere the positive electrode active material to the positive electrode substrate. Representative examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, nylon, and the like, but are not limited thereto.

The conductive material is used to provide conductivity to the electrode, and in a battery being configured, any electron-conductive material that does not cause a chemical change may be used. Examples of the conductive material may include carbon-based materials such as natural graphite, artificial graphite, carbon black, acetylene black, Ketjen black, carbon fibers, carbon nanofibers, and carbon nanotubes; metal-based materials including copper, nickel, aluminum, silver, and the like in the form of metal powder or metal fibers; conductive polymers such as polyphenylene derivatives; or mixtures thereof.

Al may be used as the positive electrode substrate, but the substrate is not limited thereto.

### Negative Electrode Active Material

The negative electrode active material may include a material capable of reversibly intercalating/deintercalating lithium ions, lithium metal, an alloy of a lithium and a metal, a material capable of being doped with and dedoped from lithium, or a transition metal oxide.

The material capable of reversibly intercalating and deintercalating lithium ions may include a carbon-based negative electrode active material, for example, crystalline carbon, amorphous carbon, or a combination thereof. Examples of the crystalline carbon may include graphite such as natural graphite or artificial graphite in an amorphous, platy, flake, spherical, or fibrous form, and examples of the amorphous carbon include soft carbon or hard carbon, mesophase pitch carbonized products, calcined coke, etc.

As the alloy of lithium and a metal, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of being doped with and dedoped from lithium, a Si-based negative electrode active material or a Sn-based negative electrode active material may be used. The Si-based negative electrode active material may be silicon, a silicon-carbon composite, SiOₓ (0<x<2), a Si-Q alloy (where Q is selected from an alkali metal, an alkaline earth metal, a Group XIII element, a Group XIV element excluding Si, a Group XV element, a Group XVI element, a transition metal, a rare earth element, or a combination thereof), or a combination thereof. The Sn-based negative electrode active material may be Sn, SnO₂, a Sn-based alloy, or a combination thereof.

The silicon-carbon composite may be a composite of silicon and amorphous carbon. According to one embodiment, the silicon-carbon composite may be in the form of silicon particles whose surfaces are coated with amorphous carbon. For example, the silicon-carbon composite may include a secondary particle (a core) in which silicon primary particles are assembled and an amorphous carbon coating layer (a shell) located on the surface of the secondary particle. The amorphous carbon may also be located between the silicon primary particles, and for example, the silicon primary particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer located on the surface of the core.

The Si-based negative electrode active material or the Sn-based negative electrode active material may be used in combination with the carbon-based negative electrode active material.

### Negative Electrode

The negative electrode for the secondary battery 100 may include a negative electrode substrate and a negative electrode mixture layer located on the negative electrode substrate. The cathode mixture layer may include a negative electrode active material and may further include a binder and/or a conductive material.

For example, the negative electrode mixture layer may include 90 to 99 wt % of the negative electrode active material, 0.5 to 5 wt % of the binder, and 0 to 5 wt % of the conductive material.

The binder serves to well adhere the negative electrode active material particles to each other and also to well adhere the negative electrode active material to the negative electrode substrate. As the binder, a non-aqueous binder, an aqueous binder, a dry binder, or a combination thereof may be used.

As the non-aqueous binder, polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof may be used.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, polyester resin, (meth)acrylic resin, phenolic resin, epoxy resin, polyvinyl alcohol, or a combination thereof.

When the aqueous binder is used as the negative electrode binder, a cellulose-based compound capable of providing viscosity may be further included. This cellulose-based compound may be used by mixing one or more of carboxymethyl cellulose, hydroxypropyl methyl cellulose, methyl cellulose, or alkali metal salts thereof. As the alkali metal, Na, K, or Li may be used.

The dry binder is a polymer material capable of being fiberized and may be, for example, polytetrafluoroethylene, polyvinylidene fluoride, a polyvinylidene fluoride-hexafluoropropylene copolymer, polyethylene oxide, or a combination thereof.

The conductive material is used to provide conductivity to an electrode, and any material may be used in the battery being constructed as long as it is an electronically conductive material that does not cause a chemical change. Specific examples may include carbon-based materials such as natural graphite, artificial graphite, carbon black, acetylene black, Ketjen black, carbon fibers, carbon nanofibers, and carbon nanotubes; metal-based materials in the form of metal powder or metal fibers, including copper, nickel, aluminum, silver, or the like; conductive polymers such as polyphenylene derivatives; or mixtures thereof.

As the negative electrode current collector, a copper foil, a nickel foil, a stainless steel foil, a titanium foil, nickel foam, copper foam, a polymer substrate coated with a conductive metal, or a combination selected therefrom may be used.

### Separator 30

According to the type of secondary battery 100, the separator 30 may be present between the first electrode 10 and the second electrode 20. As such a separator, polyethylene, polypropylene, polyvinylidene fluoride, or a multilayer film including two or more layers thereof may be used, and of course, mixed multilayer films such as a polyethylene/polypropylene two-layer separator, a polyethylene/polypropylene/polyethylene three-layer separator, and/or a polypropylene/polyethylene/polypropylene three-layer separator may be used.

The separator 30 may include a porous substrate and a coating layer including an organic material, an inorganic material, or a combination thereof located on one surface or both surfaces of the porous substrate.

The porous substrate may be a polymer film formed of any one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, Teflon, and polytetrafluoroethylene, or a copolymer or mixture of two or more thereof.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof, but is not limited thereto.

The organic material and the inorganic material may be present in a state in which the organic material and the inorganic material are mixed in one coating layer or may be present in a stacked form in which a coating layer including the organic material and a coating layer including the inorganic material are stacked.

### Electrolyte

The electrolyte for the secondary battery 100 may include a non-aqueous organic solvent and a lithium salt.

The non-aqueous organic solvent serves as a medium through which ions involved in an electrochemical reaction of the battery can move.

The non-aqueous organic solvent may be a carbonate-based solvent, an ester-based solvent, an ether-based solvent, a ketone-based solvent, an alcohol-based solvent, an aprotic solvent, or a combination thereof.

As the carbonate-based solvent, dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), or the like may be used.

As the ester-based solvent, methyl acetate, ethyl acetate, n-propyl acetate, dimethyl acetate, methyl propionate, ethyl propionate, decanolide, mevalonolactone, valerolactone, caprolactone, or the like may be used.

As the ether-based solvent, dibutyl ether, tetraglyme, diglyme, dimethoxyethane, 2-methyltetrahydrofuran, 2,5-dimethyltetrahydrofuran, tetrahydrofuran, or the like may be used. Additionally, as the ketone-based solvent, cyclohexanone or the like may be used. As the alcohol-based solvent, ethyl alcohol, isopropyl alcohol, or the like may be used. In addition, as the aprotic solvent, nitriles such as R—CN (where R is a linear, branched, or cyclic hydrocarbon group having 2 to 20 carbon atoms and may include a double bond, an aromatic ring, or an ether group); amides such as dimethylformamide or the like; dioxolanes such as 1,3-dioxolane, 1,4-dioxolane, or the like; sulfolanes; or the like may be used.

The non-aqueous organic solvent may be used alone or in a mixture of two or more.

In addition, when the carbonate-based solvent is used, a cyclic carbonate and a chain carbonate may be mixed and used, and the cyclic carbonate and the chain carbonate may be mixed in a volume ratio of 1:1 to 1:9.

The lithium salt is a material that dissolves in an organic solvent and acts as a source of lithium ions in the battery to enable the basic operation of a lithium battery and promote the movement of lithium ions between a positive electrode and a negative electrode. Representative examples of the lithium salts may include one or more selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂ₓ₊₁SO₂)(C_{y}F_{2y+1}SO₂) (x and y are integers from 1 to 20), lithium trifluoromethanesulfonate, lithium tetrafluoroethanesulfonate, lithium difluorobis(oxalato)phosphate (LiDFOB), and lithium bis(oxalato)borate (LiBOB).

As shown in FIG. 1, the electrode assembly 40 may be formed in a stack shape in which the first electrode 10, the second electrode 20, and the separator 30 are stacked. Alternatively, as shown in FIG. 2, the electrode assembly 40 may be formed in a form in which the first electrode 10, the second electrode 20, and the separator 30 located between the first electrode 10 and the second electrode 20, which are stacked, are wound.

The case 50 may accommodate the electrode assembly 40. The case 50 may seal the electrode assembly 40 together with the electrolyte.

The case 50 may be formed of a flexible outer material such as a pouch. The case 50 may include insulating layers (not shown) formed on both surfaces of a thin metal layer (not shown) such as aluminum and may be formed through a forming process such as drawing.

A tab 70 may extend from the electrode assembly 40. The tab 70 may be connected to the electrode assembly 40 and extend to the outside of the case 50.

The tab 70 may include a first tab 71 and a second tab 72. The first tab 71 and the second tab 72 may extend in the same direction from one side of the electrode assembly 40. Alternatively, unlike what is shown in FIG. 2, the first tab 71 and the second tab 72 may extend in opposite directions from both sides of the electrode assembly 40.

The first tab 71 may be electrically connected to the first electrode 10. The first tab 71 may be formed by extending a substrate of the first electrode 10. For example, the first tab 71 may be formed by extending the positive electrode substrate. Alternatively, the first tab 71 may have one side bonded to the substrate of the first electrode 10 and the other side extending from the substrate of the first electrode 10. For example, the first tab 71 may have one side bonded to the positive electrode substrate and the other side extending from the positive electrode substrate.

The second tab 72 may be electrically connected to the second electrode 20. The second tab 72 may be formed by extending a substrate of the second electrode 20. For example, the second tab 72 may be formed by extending the negative electrode substrate. Alternatively, the second tab 72 may have one side bonded to the substrate of the second electrode 20 and the other side extending from the substrate of the second electrode 20. For example, the second tab 72 may have one side bonded to the negative electrode substrate and the other side extending from the negative electrode substrate.

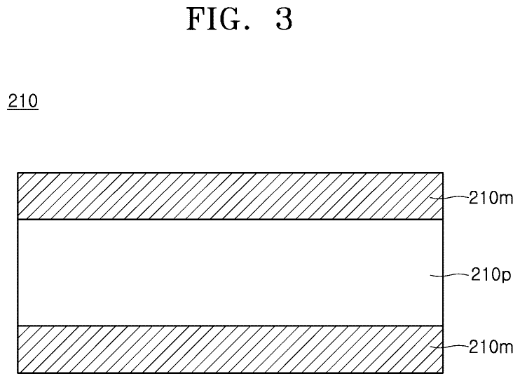

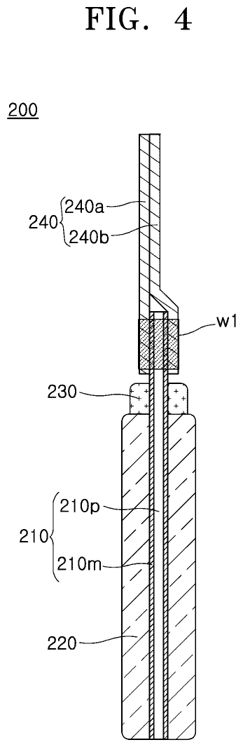

FIG. 3 is a schematic view showing a composite substrate according to one embodiment of the present disclosure. FIG. 4 is a schematic view showing an electrode according to one embodiment of the present disclosure.

Referring to FIGS. 1 to 4, the secondary battery 100 according to one embodiment of the present disclosure includes the electrode assembly 40 and the case 50. The electrode assembly 40 includes the first electrode 10 and the second electrode 20. Additionally, the electrode assembly 40 may further include the separator 30 located between the first electrode 10 and the second electrode 20.

In FIG. 4, an electrode is denoted by reference numeral 200.

The electrode 200 according to one embodiment of the present disclosure may include at least one of the first electrode 10 and the second electrode 20. Therefore, the descriptions of the electrode 200 described herein may be applied to the first electrode 10 and/or the second electrode 20.

The electrode 200 may include a composite substrate 210 and a substrate tab 240. Additionally, the electrode 200 may further include a mixture layer 220.

The composite substrate 210 may perform an identical or similar role to the positive electrode substrate and/or the negative electrode substrate described with reference to FIGS. 1 and 2. The composite substrate 210 may allow current to flow through the electrode 200. The composite substrate 210 may collect current from the mixture layer 220 and provide a path through which current can flow between the mixture layer 220 and the substrate tab 240.

FIG. 3 shows a cross section of the composite substrate 210. As shown in FIG. 3, the composite substrate 210 may include one or two metal layers 210m and an insulating layer 210p.

The insulating layer 210p may allow the composite substrate 210 to maintain its shape. For example, the insulating layer 210p may allow the composite substrate 210 to maintain its shape without bending even when the metal layer 210m is formed to have a relatively thin thickness.

The insulating layer 210p may include a material having a lower density than the metal layer 210m. Through this, the insulating layer 210p may allow the weight of the composite substrate 210 to be reduced as compared to a case in which the composite substrate 210 is formed only of the metal layer 210m. For example, the insulating layer 210p includes an insulating material.

The insulating material may include a polymer material and/or a polymer composite material.

For example, the polymer material may include polyamide, polyterephthalate, polyimide, polyethylene, polypropylene, polystyrene, polyvinyl chloride, aramid, polyphthalamide, acrylonitrile-butadiene-styrene copolymer, polybutylene terephthalate, poly-para-phenylene terephthalamide, ethylene propylene rubber, polyoxymethylene, epoxy resin, phenolic resin, polytetrafluoroethylene, polyphenylene sulfide, polyvinylidene fluoride, silicone rubber, polycarbonate, cellulose and derivatives thereof, starch and derivatives thereof, protein and derivatives thereof, polyvinyl alcohol and crosslinked products thereof, polyethylene glycol, crosslinked products thereof, etc.

For example, the polymer composite material may include a composite material including a polymer material and an inorganic material. For example, the inorganic material may include ceramics, glass, ceramic composites, and the like.

For example, the insulating layer 210p may be formed in the form of a plate having an approximately quadrangular shape. However, the shape of the insulating layer 210p is not limited thereto. For example, the insulating layer 210p may be formed to correspond to the shape of the composite substrate 210. For example, the insulating layer 210p may be formed in a shape in which one side and/or the other side has a curved surface and which extends from one side toward the other side. Alternatively, for example, the insulating layer 210p may have one side and/or the other side formed in a pointed shape and may be formed in a shape extending from one side toward the other side. Hereinafter, an example in which the insulating layer 210p is formed in the form of a plate having an approximately quadrangular shape will be described.

The metal layer 210m may perform a conductive and/or current collecting function in the composite substrate 210. The metal layer 210m may provide a path through which electrons can move to the mixture layer 220.

The metal layer 210m may include a conductive material. The conductive material may include, for example, a metal material, a carbon-based material, a combination thereof, etc.

For example, the metal material may include silver (Ag), copper (Cu), gold (Au), aluminum (Al), tungsten (W), zinc (Zn), nickel (Ni), iron (Fe), platinum (Pt), tin (Sn), an alloy of at least two thereof, etc.

For example, the carbon-based material may include graphite, carbon nanotubes, graphene, and the like.

The metal layer 210m may be provided to cover at least one surface of the insulating layer 210p. For example, the metal layer 210m may be provided on one surface of the insulating layer 210p. Alternatively, for example, as shown in FIGS. 3 and 4, the metal layer 210m may be provided on both surfaces of the insulating layer 210p. Hereinafter, an example in which the metal layer 210m is provided on both surfaces of the insulating layer 210p will be described.

In this case, the metal layer 210m may include a first metal layer formed on one surface of the insulating layer 210p and a second metal layer formed on the other surface of the insulating layer 210p. Accordingly, the first metal layer and the second metal layer may be insulated from each other by the insulating layer 210p.

With this structure, the composite substrate 210 according to one embodiment of the present disclosure may contribute to weight reduction of the electrode 200. In addition, it is possible to prevent a short circuit from occurring between the electrodes 200 that were insulated by the separator 30 even when the separator 30 is damaged and/or shrinks. Additionally, the composite substrate 210 may prevent the electrode 200 from being damaged by external factors through the insulating layer 210p. This may be due to the fact that the insulating layer 210p has better elongation than the metal layer 210m. Additionally, the composite substrate 210 may improve safety by improving a voltage drop and reducing resistance through the insulating layer 210p. Furthermore, the secondary battery 100 including the composite substrate 210 may also have improved safety.

As described with reference to FIGS. 1 and 2, the mixture layer 220 includes an active material. The mixture layer 220 may further include a conductive material, a binder, etc.

The mixture layer 220 may be provided on at least one surface of the composite substrate 210. The mixture layer 220 may be located in contact with the metal layer 210m on the composite substrate 210. For example, the mixture layer 220 may be provided on one surface of the composite substrate 210. Alternatively, for example, as shown in FIGS. 3 and 4, the mixture layer 220 may be provided on both sides of the composite substrate 210. Hereinafter, an example in which the mixture layer 220 is provided on both surfaces of the composite substrate 210 will be described.

The mixture layer 220 may be formed in a slurry state and formed by being coated on the composite substrate 210. Alternatively, the mixture layer 220 may be formed in a free-standing film state and formed by being attached (e.g., adhered) to the composite substrate 210.

The mixture layer 220 may be provided on a portion of the composite substrate 210. The mixture layer 220 may be provided on a portion of one surface of the composite substrate 210 or may be provided on portions of both surfaces. In this case, when the mixture layer 220 is provided on both surfaces of the composite substrate 210, the mixture layer 220 may include a first mixture layer provided on one surface of the composite substrate 210 and a second mixture layer provided on the other surface of the composite substrate 210, which may be substantially opposite the one surface. For example, as shown in FIG. 4, the first mixture layer and the second mixture layer may be provided symmetrically about the composite substrate 210. Alternatively, for example, the first mixture layer and the second mixture layer may be disposed to be offset from each other on the composite substrate 210 and/or may be formed to have different contact areas with the composite substrate 210.

Accordingly, the composite substrate 210 may have a region where the mixture layer 220 is not provided and is exposed to the outside. For example, one side of the composite substrate 210 may be exposed to the outside and the mixture layer 220 may be provided on the other side of the composite substrate. The region in the composite substrate 210 exposed to the outside may provide a space that can be electrically connected to the outside. For example, the region in the composite substrate 210 exposed to the outside may be electrically connected to the substrate tab 240.

In this case, as described herein, the two metal layers 210m located on both surfaces of the insulating layer 210p may be insulated from each other. Accordingly, the two metal layers 210m need to be electrically connected to each other so that current can flow between the two metal layers 210m.

To this end, the electrode 200 may further include the substrate tab 240.

The substrate tab 240 may be electrically connected to the composite substrate 210. The substrate tab 240 may have one side bonded to one side of at least one surface of the composite substrate 210.

The substrate tab 240 may be electrically connected to the metal layer 210m. The substrate tab 240 may be bonded and connected to the metal layer 210m. In FIG. 4, w1 schematically indicates a region in which the substrate tab 240 and the metal layer 210m are bonded. Hereinafter, w1 may be referred to as a first joint portion. The substrate tab 240 may be bonded to the composite substrate 210 at the first joint portion w1.

For example, the substrate tab 240 may have one side bonded to one side of the first metal layer. The substrate tab 240 may include a first substrate tab 240a in contact with the first metal layer. The first substrate tab 240a may be formed such that one side is in contact with the first metal layer and the other side extends from the first metal layer.

For example, the substrate tab 240 may have one side bonded to one side of the second metal layer. The substrate tab 240 may include a second substrate tab 240b in contact with the second metal layer. The second substrate tab 240b may be formed such that one side is in contact with the second metal layer, and the other side extends from the second metal layer.

Additionally, for example, the substrate tab 240 may include the first substrate tab 240a having one side bonded to one side of the first metal layer and the second substrate tab 240b having one side bonded to one side of the second metal layer. The first substrate tab 240a may be formed such that one side is in contact with the first metal layer and the other side extends from the first metal layer. Additionally, the second substrate tab 240b may be formed such that one side is in contact with the second metal layer and the other side extends from the second metal layer. In this case, the other side of the first substrate tab 240a and the other side of the second substrate tab 240b may be in contact with each other. Through this, the first substrate tab 240a and the second substrate tab 240b may be electrically connected. Additionally, the first metal layer and the second metal layer may be electrically connected to each other.

However, the shape or number of substrate tabs 240 is not limited thereto. For example, unlike what is shown in FIG. 4, the substrate tab 240 may be formed as a single piece that is bent or folded. In this case, the substrate tab 240 may have one side bonded to one side of the first metal layer and the other side bonded to one side of the second metal layer. The substrate tab 240 may be formed to surround one side of the composite substrate 210.

Hereinafter, an example in which the substrate tab 240 includes the first substrate tab 240a and the second substrate tab 240b may be described.

Meanwhile, the substrate tab 240 may include a conductive material so that the substrate tab has conductivity. For example, the substrate tab 240 may include a first metal. Alternatively, for example, the substrate tab 240 may be formed of the first metal. For example, the first metal may include aluminum (Al), copper (Cu), magnesium (Mg), or an alloy of two or more thereof.

Additionally, the electrode 200 may further include a protective layer 230. The protective layer 230 may be provided between the mixture layer 220 and the composite substrate 210. The protective layer 230 may prevent the composite substrate 210 from being deformed and/or prevent cracks from occurring on the composite substrate 210.

To this end, the protective layer 230 may include a first layer including an insulating material. The first layer may be applied and formed between the composite substrate 210 and the mixture layer 220. Alternatively, the first layer may be attached and formed between the composite substrate 210 and the mixture layer 220.

In this case, for example, the insulating material may include polysulfone, polyurethane, polyamide, 6,6 nylon, polycarbonate (PC), polytetrafluoroethylene (PTFE), polymethyl methacrylate (PMMA), polyethylene terephthalate (PET), a combination thereof, etc.

Meanwhile, when the first layer is attached and formed between the composite substrate 210 and the mixture layer 220, the protective layer 230 may further include a second layer including an adhesive material. The second layer may be located between the first layer and the composite substrate 210 and attach the first layer to the composite substrate 210.

In this case, for example, the adhesive material may include an acrylic-based adhesive, a rubber-based adhesive, a silicone-based adhesive, a hot-melt adhesive, a combination thereof, etc.

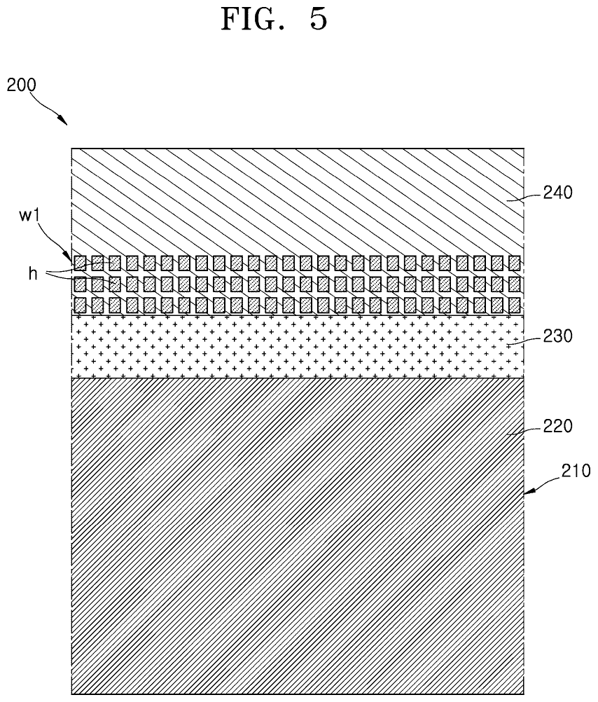

FIG. 5 is a view schematically showing an electrode according to one embodiment of the present disclosure.

An electrode 200 according to one embodiment of the present disclosure (including, for example, the electrode 200 described with reference to FIGS. 3 and 4) may include a composite substrate 210 and a substrate tab 240.

The composite substrate 210 according to one embodiment of the present disclosure may include the metal layer 210m and the insulating layer 210p. The substrate tab 240 according to one embodiment of the present disclosure may include a first metal and may be bonded to one side of at least one surface of the composite substrate 210.

The substrate tab 240 may have a surface including a second metal different from the first metal. In this case, the surface of the substrate tab 240 may be a surface of the substrate tab 240 that is not in contact with the composite substrate 210. Additionally, a portion in the surface of the substrate tab 240 that includes the second metal may correspond to a first joint portion w1.

The substrate tab 240 may comprise the second metal that can be detected on the surface of the substrate tab 240. For example, when the surface of the substrate tab 240 is analyzed through X-ray diffraction analysis (XRD), the second metal that is different from the first metal may be detected.

In this case, the melting point of the second metal may be higher than the melting point of the first metal.

For example, the melting point of the second metal may be at least 350 °C higher than the melting point of the first metal. Alternatively, for example, the melting point of the second metal may be at least 380 °C higher than the melting point of the first metal. Alternatively, for example, the melting point of the second metal may be at least 400 °C higher than the melting point of the first metal. Alternatively, for example, the melting point of the second metal may be at least 420 °C higher than the melting point of the first metal. Alternatively, for example, the melting point of the second metal may be at least 450 °C higher than the melting point of the first metal.

FIG. 5 shows a state in which the composite substrate 210 and the substrate tab 240 are bonded to form the first joint portion w1. For example, the substrate tab 240 may be bonded to the metal layer 210m of the composite substrate 210 through the first joint portion w1.

The first joint portion w1 may be formed by welding. For example, the first joint portion w1 may be formed by ultrasonic welding. However, the method by which the composite substrate 210 and the substrate tab 240 are bonded is not limited thereto. For example, the first joint portion w1 may be formed by spot welding, laser welding, PWM welding, or the like.

In FIG. 5, h corresponds to an exaggerated illustration of a pinhole h that may form in the first joint portion w1. In FIG. 5, the shaded pinhole h visually represents a region in which the pinhole h could have formed but did not form.

Unlike what is shown in FIG. 5, the pinhole h may be visible with the naked eye or may not be visible. Additionally, the pinhole h may form in the surface of the substrate tab 240 or may form in the entire region extending inward from the surface of the substrate tab 240.

Accordingly, in the first joint portion w1, the pinhole h may hardly occur (e.g., be of a size that is invisible to the naked eye).

For example, the first joint portion w1 may have a volume fraction of the pinhole h of less than 5%. Alternatively, for example, the first joint portion w1 may have a volume fraction of the pinhole h of less than 4%. Alternatively, for example, the first joint portion w1 may have a volume fraction of the pinhole h of less than 3%. In this case, the volume fraction of the pinhole h represents the fraction of the region in which the pinhole h occurs in the entire region in which the first joint portion w1 is formed.

With this structure, the bonding strength between the substrate tab 240 and the composite substrate 210 at the first joint portion w1 may be high. Additionally, the electrode 200 according to one embodiment of the present disclosure may have improved safety and lifetime, reduced voltage drop, and reduced resistance.

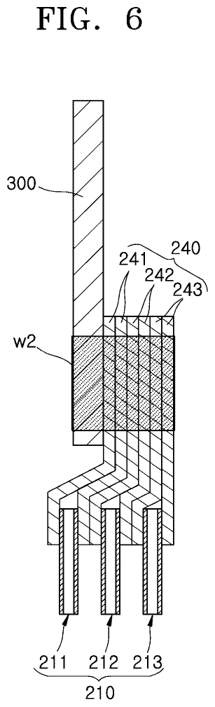

FIG. 6 is a view schematically showing an electrode according to one embodiment of the present disclosure.

A secondary battery 100 according to one embodiment of the present disclosure (including, for example, the secondary battery 100 described with reference to FIGS. 1 to 5) may include an electrode assembly 40 including a first electrode 10, a second electrode 20, and a separator 30 located between the first electrode 10 and the second electrode 20, a case 50 that accommodates the electrode assembly 40, and a lead tab 300. FIG. 6 shows the secondary battery 100 in which the case 50 is omitted.

For example, the electrode assembly 40 may be formed in a stacked form in which electrodes 200 are stacked. In this case, each of the electrodes 200 may include at least one of the first electrode 10 and the second electrode 20.

For example, the electrode assembly 40 may be formed in a V-stack form or an H-stack form in which a plurality of first electrodes 10, a plurality of second electrodes 20, and a plurality of separators 30 are stacked. Alternatively, for example, the electrode assembly 40 may be formed in a Z-stack form in which a plurality of first electrodes 10, a plurality of second electrodes 20, and one separator 30 are stacked.

For example, when the electrode assembly 40 is formed in a stacked form, as shown in FIG. 6, the composite substrate 210 of each of the plurality of electrodes 200 may extend to one side. FIG. 6 shows an example in which a plurality of composite substrates 211, 212, and 213 extend to one side. Although FIG. 6 shows an example in which three composite substrates 211, 212, and 213 extend, the number of composite substrates 210 included in the electrode assembly 40 is not limited thereto.

For example, when the electrode assembly 40 is formed in a stacked form, as shown in FIG. 6, the substrate tab 240 of each of the plurality of electrodes 200 may extend to one side. In this case, each of the plurality of substrate tabs 241, 242, and 243 may be bonded to a corresponding one of the plurality of composite substrates 211, 212, and 213. Although FIG. 6 shows an example in which three pairs of substrate tabs 241, 242, and 243 extend, the number of substrate tabs 240 included in the electrode assembly 40 is not limited thereto.

The lead tab 300 may be electrically connected to the electrode assembly 40 and at least a portion thereof may be exposed to the outside of the case 50. The tab 70 described with reference to FIGS. 1 and 2 may correspond to the lead tab 300. Alternatively, the tab 70 described with reference to FIGS. 1 and 2 may correspond to the lead tab 300 and the substrate tab 240.

FIG. 6 schematically shows a joint portion in which the electrode assembly 40 and the lead tab 300 are bonded in the electrode 200.

The lead tab 300 may be bonded to the electrode assembly 40 and may be electrically connected to the electrode assembly 40. The lead tab 300 may be bonded to the electrode 200 and may be electrically connected to the electrode 200.

The lead tab 300 may be electrically connected to the substrate tab 240 extending from the electrode 200. The lead tab 300 may be bonded to and electrically connected to the substrate tab 240. For example, the lead tab 300 may be bonded to the substrate tab 240 through ultrasonic welding, laser welding, spot welding, PMW welding, etc. However, a method by which the lead tab 300 and the substrate tab 240 are electrically connected is not limited thereto. For example, the lead tab 300 may be connected to the substrate tab 240 through solder cream, solder paste, electrical tape, etc. In FIG. 6, a region in which the lead tab 300 and the substrate tab 240 are bonded is denoted by w2. Hereinafter, w2 may be referred to as a second joint portion.

Accordingly, the lead tab 300 may include the second joint portion w2 formed to be bonded to the substrate tab 240 on one side. Additionally, the lead tab 300 may have the other side located outside the case 50. The lead tab 300 may be formed to extend from one side to the other side. For example, the lead tab 300 may be formed in approximately a plate shape and/or may be formed in a flexible shape. However, the shape of the lead tab 300 is not limited thereto.

As described herein, the substrate tab 240 may include the first joint portion w1 formed to be bonded to the composite substrate 210 on one side. Additionally, the substrate tab 240 may include the second joint portion w2 formed to be bonded to the lead tab 300 on the other side.

Meanwhile, as shown in FIG. 6, the electrode assembly 40 may include a plurality of first electrodes 10 and/or second electrodes 20. In this case, one lead tab 300 may be bonded to a plurality of substrate tabs 241, 242, and 243.

For example, although not shown, the lead tab 300 may include a first lead tab electrically connected to the first electrode 10 and/or a second lead tab electrically connected to the second electrode 20.

For example, when a plurality of first electrodes 10 are stacked, substrate tabs of each of the plurality of first electrodes 10 may extend to one side. A plurality of substrate tabs of the first electrode 10 extending to one side may be bonded to one or more first lead tabs.

For example, when a plurality of second electrodes 20 are stacked, substrate tabs of each of the plurality of second electrodes 20 may extend to one side or the other. The plurality of substrate tabs of the second electrode 20 extending to one side or the other side may be bonded to one or more second lead tabs.

The plurality of first electrodes 10 and the plurality of second electrodes 20 may be alternately stacked with the separator 30 disposed therebetween.

Substrate tabs of the first electrode 10 and substrate tabs of the second electrode 20 may extend in the same direction as each other. In this case, the first lead tab and the second lead tab may extend in the same direction.

Alternatively, the substrate tabs of the first electrode 10 and the substrate tabs of the second electrode 20 may extend in different directions. In this case, the first lead tab and the second lead tab may extend in different directions.

With this structure, the secondary battery 100 according to one embodiment of the present disclosure may have improved voltage drop, lifetime, and safety.

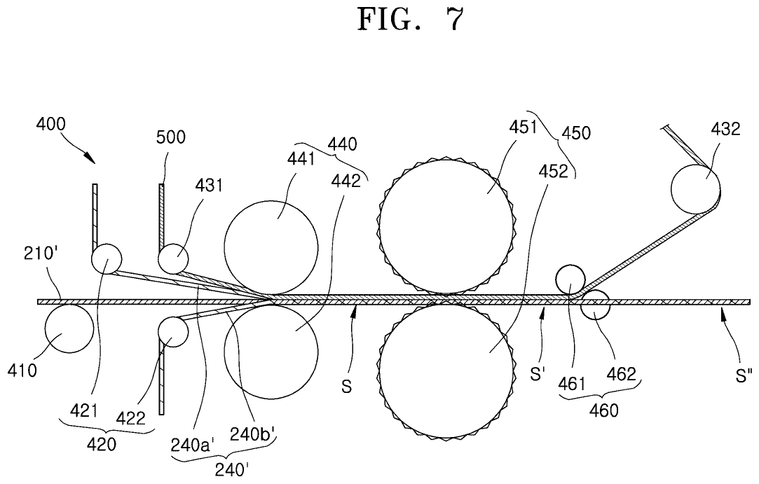

FIG. 7 is a view schematically showing an electrode manufacturing apparatus according to one embodiment of the present disclosure.

An electrode manufacturing apparatus 400 according to one embodiment of the present disclosure (for example, including the electrode 200 described with reference to FIGS. 3 to 6) may manufacture the electrode 200.

To this end, the electrode manufacturing apparatus 400 may include a first transfer unit 410, a second transfer unit 420, a third transfer unit 431, and a pressing unit 450. In addition, the electrode manufacturing apparatus 400 may further include a feeding unit 440. Additionally, the electrode manufacturing apparatus 400 may further include a separation roller 460. Additionally, the electrode manufacturing apparatus 400 may further include a sub-roller 432.

However, the components included in the electrode manufacturing apparatus 400 are not limited to those shown in FIG. 7. The electrode manufacturing apparatus 400 may include only some of the components shown in FIG. 7 and/or may include additional components in addition to the components shown in FIG. 7. For example, the electrode manufacturing apparatus 400 may include an edge position control (EPC) sensor, a center position control (CPC) sensor, etc. Alternatively, for example, the electrode manufacturing apparatus 400 may further include a tension roller, a reel change position (R/C), etc.

The first transfer unit 410 may transfer a composite substrate sheet 210′.

The composite substrate sheet 210′ may include two metal layers 210m and an insulating layer 210p located between the two metal layers 210m.

The composite substrate sheet 210′ may correspond to the composite substrate 210 described with reference to FIGS. 3 to 5 and may be the same as the composite substrate 210 or may represent a sheet at a stage before the composite substrate 210 is manufactured. For example, the composite substrate sheet 210′ may itself become the composite substrate 210. Alternatively, for example, the composite substrate sheet 210′ may be cut at predetermined intervals to become the composite substrate 210.

In this case, the composite substrate sheet 210′ may be transferred by the first transfer unit 410 while being unwound from a wound state. Alternatively, the composite substrate sheet 210′ may be transferred by the first transfer unit 410 in an unwound sheet state.

For example, the first transfer unit 410 may be formed in the form of a roller that has an approximately cylindrical shape and rotate about a rotation axis. In this case, the first transfer unit 410 may transfer the composite substrate sheet 210′ located on the first transfer unit 410 while rotating clockwise or counterclockwise. However, the shape of the first transfer unit 410 is not limited thereto, and for example, the first transfer unit 410 may be formed in various shapes such as the shape of a conveyor belt.

The first transfer unit 410 may transport the composite substrate sheet 210′ toward the feeding unit 440. Further/alternatively, the first transfer unit 410 may transport the composite substrate sheet 210′ toward the pressing unit 450.

The second transfer unit 420 may transfer a substrate tab sheet 240′.

The substrate tab sheet 240 corresponds to the substrate tab 240 described with reference to FIGS. 3 to 5 and may be the same as the substrate tab 240 or may represent a sheet at a stage before the substrate tab 240 is manufactured. For example, the substrate tab sheet 240′ may itself be the substrate tab 240. Alternatively, for example, the substrate tab sheet 240′ may be cut at predetermined intervals to become the substrate tab 240.

The substrate tab sheet 240′ may include a first metal.

The substrate tab sheet 240′ may be transferred by the second transfer unit 420 while being unwound from a wound state. Alternatively, the substrate tab sheet 240′ may be transferred by the second transfer unit 420 in an unwound sheet state.

For example, the second transfer unit 420 may be formed in the form of a roller that is an approximately cylindrical shape and rotate about a rotation axis. In this case, the second transfer unit 420 may transfer the substrate tab sheet 240′ located on the second transfer unit 420 while rotating clockwise or counterclockwise. However, the shape of the second transfer unit 420 is not limited thereto, and for example, the second transfer unit 420 may be formed in various shapes such as a conveyor belt shape.

The second transfer unit 420 may transfer the substrate tab sheet 240′ toward the feeding unit 440. Further/alternatively, the second transfer unit 420 may transport the substrate tab sheet 240′ toward the pressing unit 450. In this case, the second transfer unit 420 may transfer the substrate tab sheet 240′ so that the substrate tab sheet 240′ is located on the composite substrate sheet 210′.

Meanwhile, for example, as shown in FIG. 4, when an electrode 200 including two substrate tabs 240 is to be manufactured, as shown in FIG. 7, the second transfer unit 420 may include an upper transfer unit 421 that transfers a first substrate tab sheet 240a′ and a lower transfer unit 422 that transfers a second substrate tab sheet 240b′. The upper transfer unit 421 may transfer the first substrate tab sheet 240a′ so that the first substrate tab sheet 240a′ is located on an upper surface of the composite substrate sheet 210′. The lower transfer unit 422 may transfer the second substrate tab sheet 240b′ so that the second substrate tab sheet 240b′ is located on a lower surface of the composite substrate sheet 210′. Hereinafter, an example in which the electrode manufacturing apparatus 400 manufactures an electrode 200 including two substrate tabs 240 will be described.

A third transfer unit 431 may transfer the buffer sheet 500.

In this case, the buffer sheet 500 may include a second metal. The melting point of the second metal may be higher than the melting point of the first metal. For example, the melting point of the second metal may be at least 350 °C higher than the melting point of the first metal. Alternatively, for example, the melting point of the second metal may be at least 380 °C higher than the melting point of the first metal. Alternatively, for example, the melting point of the second metal may be at least 400 °C higher than the melting point of the first metal. Alternatively, for example, the melting point of the second metal may be at least 420 °C higher than the melting point of the first metal. Alternatively, for example, the melting point of the second metal may be at least 450 °C higher than the melting point of the first metal.

For example, the first metal may include copper (Cu), aluminum (Al), etc. In this case, for example, the second metal may include nickel (Ni), tungsten (W), etc.

The third transfer unit 431 may be formed in the form of a roller that is an approximately cylindrical shape and rotate about a rotation axis. In this case, the third transfer unit 431 may transport the buffer sheet 500 located on the third transfer unit 431 while rotating clockwise or counterclockwise. However, the shape of the third transfer unit 431 is not limited thereto, and for example, the third transfer unit 431 may be formed in various shapes, such as a conveyor belt shape.

The third transfer unit 431 may transfer the buffer sheet 500 toward the feeding unit 440. Further/alternatively, the third transfer unit 431 may transfer the buffer sheet 500 toward the pressing unit 450. For example, the third transfer unit 431 may transfer the buffer sheet 500 onto the substrate tab sheet 240′. In this case, when the substrate tab sheet 240′ includes the first substrate tab sheet 240a′ and the second substrate tab sheet 240b′, the third transfer unit 431 may transfer the buffer sheet 500 onto one of the first substrate tab sheet 240a′ and the second substrate tab sheet 240b′. Accordingly, the buffer sheet 500 may be transferred onto one of the two substrate tab sheets 240′.

Accordingly, the composite substrate sheet 210′, the substrate tab sheet 240′, and the buffer sheet 500 may be supplied toward the feeding unit 440.

The feeding unit 440 may stack the composite substrate sheet 210′, the substrate tab sheet 240′, and the buffer sheet 500 that are supplied to the feeding unit 440.

To this end, the feeding unit 440 may include a pair of rollers 441 and 442.

The pair of rollers 441 and 442 may be located to be spaced apart from each other. For example, the pair of rollers 441 and 442 may be located to be spaced apart from each other by a sum of the thicknesses of the composite substrate sheet 210′, the two substrate tab sheets 240a′ and 240b′, and the buffer sheet 500. Alternatively, for example, the pair of rollers 441 and 442 may be located to be spaced apart from each other within a range of ±10% of the sum of the thicknesses of the composite substrate sheet 210′, the two substrate tab sheets 240a′ and 240b′, and the buffer sheet 500. For example, the pair of rollers 441 and 442 may rotate in opposite directions. For example, when one roller 441 rotates clockwise, the other roller 442 may rotate counterclockwise. An outer surface of each of the pair of rollers 441 and 442 may be disposed to face one surface of a buffer sheet 500 and one surface of a substrate tab sheet 240′.

The feeding unit 440 may stack the composite substrate sheet 210′, the substrate tab sheet 240′, and the buffer sheet 500 to form a stacked structure S in which they are stacked. For example, the composite substrate sheet 210′, the substrate tab sheet 240′, and the buffer sheet 500 may be stacked and/or pressed to form the stacked structure S in which they are laminated.

The pressing unit 450 may press the stacked structure S. By means of the pressing unit 450, the stacked structure S becomes a pressed stacked structure S′. The pressing unit 450 may press the stacked structure S to ultrasonically weld the composite substrate sheet 210′ and the substrate tab sheet 240′.

To this end, the pressing unit 450 may include a horn 451 and an anvil 452. The pressing unit 450 may bond the stacked structure S supplied between the horn 451 and the anvil 452 by ultrasonic welding. For example, the stacked structure S may be supplied toward between the horn 451 and the anvil 452. In this case, the pressing unit 450 may apply ultrasonic waves to the stacked structure S. Further/alternatively, the horn 451 may press the stacked structure S using a knurl formed in the horn 451. In this case, the horn 451 may be located on the buffer sheet 500, and for example, the horn 451 may be in contact with the buffer sheet 500. That is, the buffer sheet 500 may be located between the horn 451 and the substrate tab sheet 240′.

Through this, the pressing unit 450 may bond the composite substrate sheet 210′ and the substrate tab sheet 240′. Accordingly, a first joint portion w1 described with reference to FIGS. 4 to 6 may be formed.

The separation roller 460 may separate the buffer sheet 500 from the pressed stacked structure S′. For example, as shown in FIG. 7, the separation roller 460 may include a pair of rollers 461 and 462. The separated buffer sheet 500 may pass between the pair of rollers 461 and 462 and may be transferred toward the sub-roller 432. The separated buffer sheet 500 may be fed back to the third transfer unit 431 and used in the electrode manufacturing process.

Accordingly, the buffer sheet 500 may be separated from the pressed stacked structure S′. A stacked structure S″ from which the buffer sheet 500 is separated may include the ultrasonic-welded composite substrate sheet 210′ and substrate tab sheet 240′.

Meanwhile, in the stacked structure S″ from which the buffer sheet 500 is separated, the substrate tab sheet 240′ may include a second metal on at least a portion of its surface. For example, in a first welded portion w1, a second metal may be detected.

In this way, the electrode manufacturing apparatus 400 according to one embodiment of the present disclosure may utilize the buffer sheet 500 to weld the composite substrate sheet 210′ and the substrate tab sheet 240′. Through this, the electrode manufacturing apparatus 400 may allow the composite substrate sheet 210′ and the substrate tab sheet 240′ to be better bonded.

Accordingly, the substrate tab sheet 240′ may have a volume fraction of pinholes of less than 5% in the portion ultrasonic-welded to the composite substrate sheet 210′ (for example, including the first joint portion w1). Alternatively, for example, the first joint portion w1 may have a volume fraction of a pinhole h of less than 4%. Alternatively, for example, the first joint portion w1 may have a volume fraction of the pinhole h of less than 3%. In this case, the volume fraction of the pinhole h represents a fraction of a region in which the pinhole h occurs in the entire region in which the first joint portion w1 is formed.

The separated stacked structure S″ may be cut at predetermined intervals to become the electrode 200. For example, the electrode 200 may be stacked together with another electrode and the separator 30 to form the electrode assembly 40. Alternatively, the separated stacked structure S″ may be used as the electrode 200. For example, the electrode 200 may be wound together with the other electrode and the separator 30 to form the electrode assembly 40.

Hereinafter, the process of welding the composite substrate sheet 210′ and the substrate tab sheet 240′ using the buffer sheet 500 will be described in more detail.

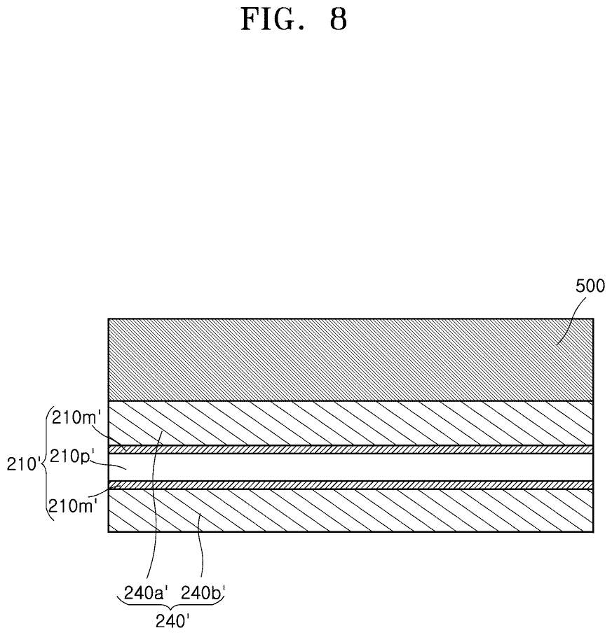

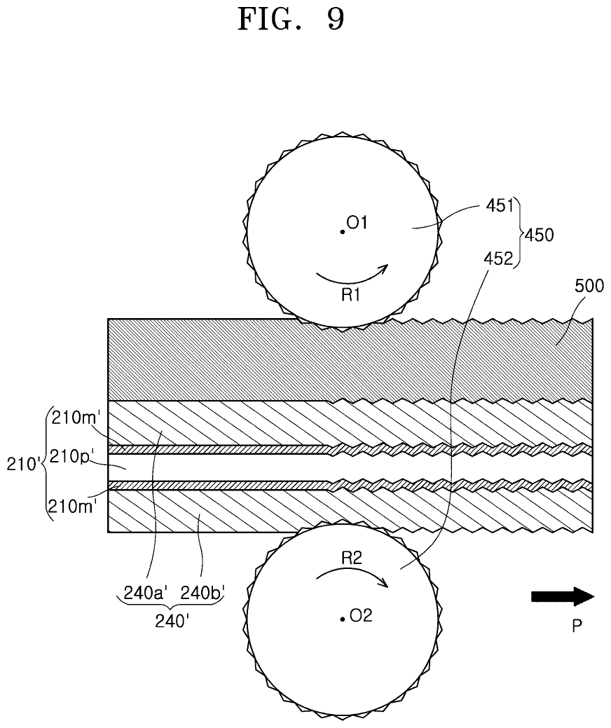

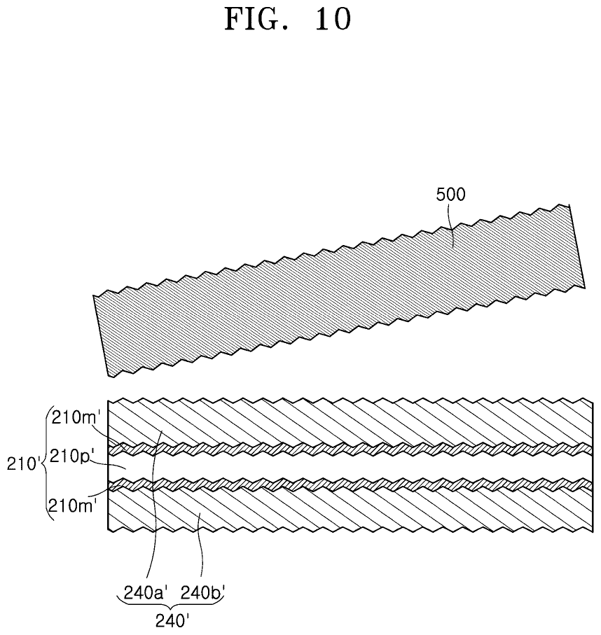

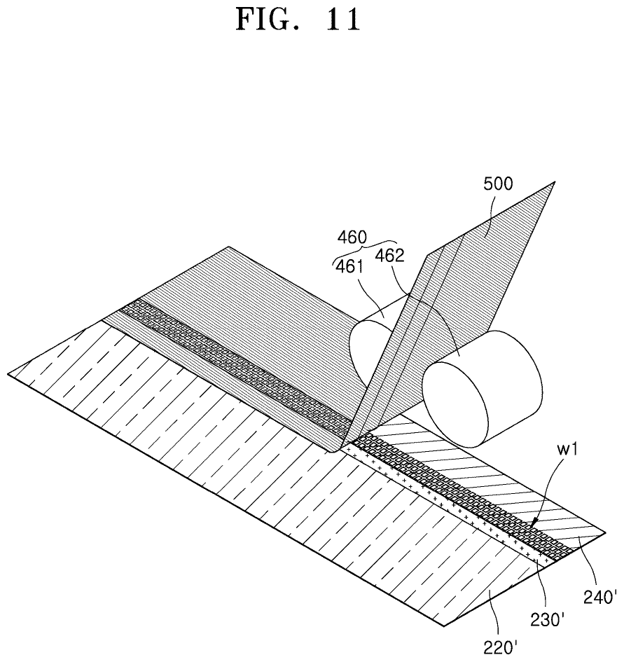

FIG. 8 is a view for describing a method of manufacturing an electrode according to one embodiment of the present disclosure. FIG. 9 is a view for describing the method of manufacturing an electrode according to one embodiment of the present disclosure. FIG. 10 is a view for describing the method of manufacturing an electrode according to one embodiment of the present disclosure. FIG. 11 is a view for describing the method of manufacturing an electrode according to one embodiment of the present disclosure.

In FIGS. 8 to 11, a process of manufacturing an electrode 200 (including, for example, the electrode 200 described with reference to FIGS. 3 to 7) by an electrode manufacturing apparatus 400 (including, for example, the electrode manufacturing apparatus 400 described with reference to FIG. 7) will be described in detail.

FIG. 8 shows an example in which a composite substrate sheet 210′, a substrate tab sheet 240′, and a buffer sheet 500 are stacked to form a stacked structure S.

As shown in FIG. 8, the composite substrate sheet 210′ may include two metal layer sheets 210m′ and an insulating layer sheet 210p′ located between the two metal layer sheets 210m′.

As shown in FIG. 8, the substrate tab sheet 240′ may be located on both surfaces of the composite substrate sheet 210′. For example, the first substrate tab sheet 240a′ may be located on one surface of a composite substrate sheet 210′, and the second substrate tab sheet 240b′ may be located on the other surface of a composite substrate sheet 210′. However, in some embodiments, unlike what is shown in FIG. 8, the substrate tab sheet (for example, 240a′) may be located only on one surface of the composite substrate sheet 210′.

As shown in FIG. 8, the buffer sheet 500 may be located on the substrate tab sheet 240′. The buffer sheet 500 may be located with the composite substrate sheet 210′ and the substrate tab sheet 240′ disposed therebetween.

FIG. 9 shows an example in which the stacked structure S shown in FIG. 8 is pressed by a pressing unit 450.

As shown in FIG. 9, the pressing unit 450 may include a horn 451 and an anvil 452. The horn 451 may press the stacked structure S while rotating about a rotation axis O1 of the horn in a first direction R1. The anvil 452 may press and/or fix the stacked structure S while rotating about a rotation axis O2 of the anvil in a second direction R2.

In FIG. 9, P indicates the moving direction of the stacked structure S. The stacked structure S may be pressed by the pressing unit 450 while passing between the horn 451 and the anvil 452 in the direction P.

In this case, as described herein, the buffer sheet 500 may include a second metal. Additionally, the second metal may have a much higher melting point than the first metal included in the substrate tab sheet 240′. For example, the second metal may have a melting point that is at least 350 °C higher than the first metal.

Accordingly, when the pressing unit 450 presses the stacked structure S, the interface between the composite substrate sheet 210′ and the substrate tab sheet 240′ (hereinafter referred to as a ‘first interface’) may melt. For example, when the pressing unit 450 presses the stacked structure S and/or applies ultrasonic waves to the stacked structure S, the metal layer sheet 210m′ having a relatively low melting point may partially melt. Additionally, for example, when the pressing unit 450 presses the stacked structure S and/or applies ultrasonic waves to the stacked structure S, the substrate tab sheet 240′ including the first metal having a relatively low melting point may partially melt. Accordingly, the composite substrate sheet 210′ and the substrate tab sheet 240′ may be bonded as the first interface melts.

On the other hand, even when the pressing unit 450 presses the stacked structure S, the interface between the substrate tab sheet 240′ and the buffer sheet 500 (hereinafter referred to as a ‘second interface’) may not melt. For example, even when the pressing unit 450 presses the stacked structure S and/or applies ultrasonic waves to the stacked structure S, the buffer sheet 500 including the second metal having a relatively high melting point may not melt. That is, the second interface may not melt and the substrate tab sheet 240′ and buffer sheet 500 may not be bonded to each other. Further/alternatively, even when a portion of the substrate tab sheet 240′ melts at the second interface, the bonding strength of the second interface may be very weak because the buffer sheet 500 does not melt. Accordingly, even after the pressing unit 450 presses the stacked structure S, the buffer sheet 500 may be easily separated from the substrate tab sheet 240′.

As described herein, the buffer sheet 500 may provide a wide buffering role so that the composite substrate sheet 210′ and the substrate tab sheet 240′ are better bonded, while not being bonded to the substrate tab sheet 240′. However, when the composite substrate sheet 210′ and substrate tab sheet 240′ are bonded by applying buffer sheet 500, a small amount of a second metal may be left on the substrate tab sheet 240′.

In this case, in order for the buffer sheet 500 to perform this buffer role well, the buffer sheet 500 may be required to be formed to an appropriate thickness. For example, the thickness of the buffer sheet 500 may be formed to be greater than or equal to 1 times and equal to or less than 1.5 times the thickness of the substrate tab sheet 240′. When the buffer sheet 500 is formed to have a thickness less than 1 times the thickness of the substrate tab sheet 240′, the width of the pressure range in which the pressing unit 450 presses the stacked structure S may be narrowed. Additionally, the range of welding conditions under which the pressing unit 450 presses the stacked structure S may be narrowed. In addition, when the buffer sheet 500 is formed to be more than 1.5 times the thickness of the substrate tab sheet 240′, even when the pressing unit 450 presses the stacked structure S, the force may not be sufficiently transmitted to the first interface. Therefore, it is preferable that the thickness of the buffer sheet 500 be formed to be at least 1 times and at most 1.5 times the thickness of the substrate tab sheet 240′.

FIGS. 10 and 11 show the process of separating a buffer sheet 500 from a stacked structure S′ pressed by a pressing unit 450. In this case, as shown in FIG. 11, the buffer sheet 500 may be formed to have a larger area than a substrate tab sheet 240′. Through this, the buffer sheet 500 may provide a wider region in which the pressing unit 450 presses a stacked structure S. Meanwhile, in FIG. 11, a protective sheet is denoted by reference numeral 230′. The protective sheet 230′ may correspond to the protective layer 230.

An electrode 200 manufactured by an electrode manufacturing apparatus 400 according to one embodiment of the present disclosure includes a composite substrate 210 including two metal layers 210m and an insulating layer 210p positioned between the two metal layers 210m; and a substrate tab 240 including a first metal and bonded to one side of at least one surface of the composite substrate 210; wherein the substrate tab 240 may include a second metal that is different from a first metal on a surface of the substrate tab.

In this case, the melting point of the second metal may be higher than the melting point of the first metal. For example, the melting point of the second metal may be at least 350 °C higher than the melting point of the first metal.

In this case, the substrate tab 240 may be bonded to the metal layer 210m of the composite substrate 210 through a first joint portion w1, and the first joint portion w1 may have a volume fraction of pinholes of less than 5%. In this case, for example, the first joint portion w1 may be formed by ultrasonic welding.

According to the present disclosure, the occurrence rate of pinholes at a joint portion between a composite substrate and a substrate tab can be reduced.

According to the present disclosure, the bonding strength between the composite substrate and the substrate tab can be improved.

According to the present disclosure, the composite substrate and the substrate tab can be easily bonded to each other.

However, effects acquirable through the present disclosure are not limited to the herein-described technical effects, and other technical effects which are not described will be clearly understood by those skilled in the art from the description of the disclosure described herein.

Although the present disclosure has been described herein with reference to limited examples and drawings, the present disclosure is not limited thereto, and various modifications and variations are possible within the scope equivalent to the technical idea of the present disclosure and the scope of the patent claims to be described below by a person having ordinary skill in the art to which the present disclosure belongs.

What is claimed is:

1. An electrode comprising:
a composite substrate comprising a metal layer comprising a first metal layer and a second metal layer and an insulating layer located between the first metal layer and the second metal layer; and
a substrate tab including a first metal and bonded to one side of at least one surface of the composite substrate,
wherein the substrate tab includes a second metal different from the first metal on a surface of the substrate tab.

2. The electrode of claim 1, wherein a melting point of the second metal is higher than a melting point of the first metal.

3. The electrode of claim 1, wherein a melting point of the second metal is at least 350 °C higher than a melting point of the first metal.

4. The electrode of claim 1, wherein the substrate tab is welded to the metal layer through a joint portion, and the joint portion has a volume fraction of pinholes of less than 5%.

5. The electrode of claim 4, wherein the joint portion is formed by ultrasonic welding.

6. The electrode of claim 1, further comprising a mixture layer provided on an other side of the composite substrate opposite the at least one surface of the composite substrate.

7. A secondary battery comprising:
an electrode assembly including a first electrode, a second electrode, and a separator located between the first electrode and the second electrode;
a case accommodating the electrode assembly; and
a lead tab that is electrically connected to the electrode assembly and exposed outside the case,
wherein at least one of the first electrode or the second electrode includes:
a composite substrate including a metal layer comprising a first metal layer and a second metal layer and an insulating layer located between the first metal layer and the second metal layer; and
a substrate tab including a first metal and having one side bonded to one side of at least one surface of the composite substrate and an other side bonded to the lead tab, and
the substrate tab includes a second metal different from the first metal on a surface of the substrate tab.

8. The secondary battery of claim 7, wherein a melting point of the second metal is higher than a melting point of the first metal.

9. The secondary battery of claim 7, wherein a melting point of the second metal is at least 350 °C higher than a melting point of the first metal.

10. The secondary battery of claim 7, wherein the substrate tab is welded to the metal layer through a joint portion, and the joint portion has a volume fraction of pinholes of less than 5%.

11. The secondary battery of claim 10, wherein the joint portion is formed by ultrasonic welding.

12. The secondary battery of claim 7, wherein the first electrode and/or the second electrode including the composite substrate further includes a mixture layer provided on the other side of the at least one surface of the composite substrate.

13. An electrode manufacturing apparatus comprising:
a first transfer unit configured to transfer a composite substrate sheet, the composite substrate sheet including a metal layer comprising a first metal layer and a second metal layer, and an insulating layer located between the first metal layer and the second metal layer;
a second transfer unit configured to transfer a substrate tab sheet including a first metal to at least one surface of the composite substrate;
a third transfer unit configured to transfer a buffer sheet including a second metal onto the substrate tab sheet; and
a pressing unit configured to press a stacked structure in which the composite substrate sheet, the substrate tab sheet, and the buffer sheet are stacked.

14. The electrode manufacturing apparatus of claim 13, wherein the pressing unit presses the stacked structure to ultrasonically weld the composite substrate sheet and the substrate tab sheet.

15. The electrode manufacturing apparatus of claim 14, wherein the substrate tab sheet has a volume fraction of pinholes of less than 5% in a portion of the substrate tab sheet that is ultrasonic-welded to the composite substrate sheet.

16. The electrode manufacturing apparatus of claim 13, further comprising a separation roller configured to separate the buffer sheet from the pressed stacked structure.

17. The electrode manufacturing apparatus of claim 16, wherein, in the stacked structure from which the buffer sheet is separated, the substrate tab sheet includes the second metal on at least a portion of a surface of the substrate tab sheet.

18. The electrode manufacturing apparatus of claim 13, wherein a melting point of the second metal is higher than a melting point of the first metal.

19. The electrode manufacturing apparatus of claim 13, wherein a melting point of the second metal is at least 350 °C higher than a melting point of the first metal.

20. The electrode manufacturing apparatus of claim 13, wherein a thickness of the buffer sheet is formed to be 1.0 to 1.5 times a thickness of the substrate tab sheet.
